(19) United States
(12) Patent Application Publication
(10) Pub. No.: US 2009/0159530 A1
(43) Pub. Date: Jun. 25, 2009

(54) PROCESS BASED ON THE USE OF ZEOLITES FOR THE TREATMENT OF CONTAMINATED WATER

(75) Inventors: Rodolfo Vignola, Monterotondo-Roma (IT); Adriano Bernardi, Monterotondo-Roma (IT); Giovanni Grillo, Roma (IT); Raffaello Sisto, Rome (IT)

Correspondence Address: OBLON, SPIVAK, MCCLELLAND MAIER & NEUSTADT, P.C., 1940 DUKE STREET, ALEXANDRIA, VA, 22314, US

(73) Assignee: ENITECNOLOGIE S.p.A., San Donato Milanese-Milan (IT)

(21) Appl. No.: 12/336,112

(22) Filed: Dec. 16, 2008

Related U.S. Application Data
(63) Continuation of application No. 10/480,643, filed on Jun. 9, 2004.

(30) Foreign Application Priority Data
Jun. 28, 2001 (IT) MI201A001362

(51) Int. Cl. C02F 1/42

(52) U.S. Cl. 210/638

(57) ABSTRACT

A process is described for the treatment of water contaminated by apolar compounds consisting of halogenated solvents, aliphatic compounds, aromatic compounds or their mixtures which consists in treating the water with one or more apolar zeolites characterized by a silica/alumina ration >50 and by the presence of structural channels having dimensions similar to those of the molecules of the contaminating compounds.

The present invention relates to a process for the treatment of water contaminated by apolar compounds based on the use of particular zeolites.

More specifically, the invention relates to a process for the treatment of water contaminated by apolar compounds consisting of halogenated organic solvents and aromatic hydrocarbons which is based on the use of apolar zeolites having structural channels with specific dimensions.

The process according to the invention can be conveniently used for the treatment of contaminated groundwater by the use of a permeable reactive barrier (PRB).

Conventional PRB for the decontamination of water contaminated by halogenated solvents are based on systems using metallic iron and/or granulated activated carbon (GAC).

The first system, functioning for the reducing capacities of the metal, is only active towards reducible substances, such as organo-chlorinated products or metals with a high oxidation number (U.S. Pat. No. 5,266,213, WO 92/19556).

Furthermore, when zero-valent iron is used, there is a reduction in the permeability of the barrier due to encrustations or the precipitation of minerals which derive from the reactions between the ions of the oxidized metal and the substances contained in the groundwater.

The second system is a non-specific absorbent and as such is not very selective with respect to interfering substances present in the water and in particular in groundwater (ions, humic acids, etc.).

If it is used for the production of permeable reactive barriers, it consequently causes exhaustion of the system in short times (Williamson, D. 2000. Construction of a funnel-and-gate treatment system for pesticide-contaminated groundwater. Chemical Oxidation and reactive barriers. Godage B. et al. Eds. In II Intl. Conf. on Remediation of chlorinated and recalcitrant compounds. Monterey, Calif., USA, Battelle Press, Columbus, (2000)), pages 257-264.

Schad, H 2000. Funnel-and-gate at a former manufactured gas plant site in Kalsruhe, Germany: design and construction. In: Chemical Oxidation and reactive barriers.

Godage B. et al. Eds., II Intl. Conf. on Remediation of chlorinated and recalcitrant compounds. Monterey, Calif., USA, Battelle Press, Columbus, (2000), 215-322.

Both systems however prove to be ineffective in removing all the main pollutants often contemporaneously present in contaminated groundwater beneath industrial sites, which frequently consist of apolar compounds such as halogenated solvents and compounds deriving from the oil industry. These are often highly toxic products, some of which are of a carcinogen nature, whose concentration in underground water must respect the strict limits established by the law.

A treatment process of contaminated water has now been found, which allows the above pollutants to be effectively and selectively removed with respect to the mineral salts normally dissolved in water.

An object of the present invention therefore relates to a process for the treatment of water contaminated by apolar compounds which consists in treating the water with one or more apolar zeolites characterized by a silica alumina ratio >50 and by the presence of structural channels having dimensions similar to those of the molecules of the contaminating compounds.

The process according to the invention is particularly effective in removing pollutants consisting of halogenated solvents such as carbon tetrachloride, tetrachloroethylene (PCE), trichloroethylene (TCE), dichloroethylene (DCE), vinylchloride (VC) and aliphatic and/or aromatic compounds deriving from the oil industry such as methyl-terbutylether (MTBE), BTEX (benzene, toluene, ethylbenzene, xylenes), naphthalene, 2-methyl-naphthalene, acenaphthene, phenanthrene.

The process according to the invention can be conveniently used for the decontamination of groundwater by the use of permeable reactive barriers (PRB). In this case, the zeolite forms the active medium of the barrier, placed in situ perpendicular to the flow of the groundwater, which when crossed by the polluted water column allows decontamination by the immobilization of the contaminating species.

The barriers can treat groundwater polluted by chlorinated solvents, cyclic or polycyclic aromatic hydrocarbons and compounds which are particularly resistant both to biodegradation and adsorption such as MTBE or vinyl chloride (VC), with a high selectivity with respect to inorganic interfering products.

Vinyl chloride is considered as being a contaminant which is difficult to eliminate. It is not sufficiently withheld, in fact, by activated carbon and its degradation requires the use of additional structures which involve the use of UV lamps.

The presence of MTBE in groundwater also represents a problem which is difficult to overcome and whose solution justifies the use of relatively costly absorbing materials (Davis et al., J. Env. Eng., 126, page 354, April 2000).

The zeolites used in the process of the invention are characterized by the presence of structural channels having dimensions ranging from 4.5 to 7.5 Å. Zeolites having structural channels with dimensions ranging from 5 to 7 Å and silica/alumina ratios >200 such as, for example, silicalite, ZSM-5 zeolite, mordenite, are preferably used.

As a result of their selectivity, zeolites have a higher absorption capacity and functioning duration than those of materials currently used in permeable reactive barriers, such as activated carbon.

This is due to the properties of this reactive medium which are based on the dimension of the structural channels, suitably calibrated for organic molecules, and on the high polarity, deriving from high silica/alumina ratios, which excludes any type of interaction with ions or polar compounds.

The zeolite therefore has a selective interaction with molecules of apolar contaminants whereas it completely excludes polar ions and molecules normally present in groundwater together with humic substances, having higher molecular dimensions than those of the structural channels.

Suitable mixtures of particular zeolites, moreover, allow the contemporaneous removal of aliphatic organochlorinated products, aromatic hydrocarbons, polyaromatic hydrocarbons, characteristic components of oil products.

ZSM-5 zeolite and mordenite, with an Si/Al ratio >200, are materials known as molecular sieves or as carriers for catalysts, but their use as active components for the production of PRB has not yet been described in literature.

ZSM-5 zeolite is particularly suitable for aliphatic, halogen-aliphatic and mono-aromatic molecules, such as BTEX and halogen-benzene-derivatives.

Mordenite, on the other hand, is suitable for aromatic molecules with two or more aromatic rings, and halogen- and alkyl-substituted.

### BRIEF DESCRIPTION OF THE DRAWINGS

FIG. 1 shows the Langmuir isotherm for the adsorption of TCE on silicalite.

FIG. 2 depicts the removal efficiency of TCE from different solutions with silicalite.

FIG. 3 shows the influence of the ionic strength on the adsorption of TCE with silicalite.

FIG. 4 provides the Freudlich isotherm for the adsorption of VC on silicalite.

FIG. 5 depicts the Adsorption of toluene on silicalite (average concentrations observed in groundwater)

FIG. 6 shows the transformations undergone by tetrachloroethylene at a concentration of 1 ppm in groundwater which moves at a Darcy velocity of 1 m/day in a reactive barrier containing granular Fe°.

FIG. 7 illustrates a simulation of the functioning of a zeolite barrier after a year; the groundwater moves at 1 meter/day; where the contaminant is 1 ppm of TCE.

FIG. 8 refers to the expected duration of a zeolite barrier. Advance of the saturation front with time in a zeolite barrier under various conditions of groundwater concentration and velocity.

### DESCRIPTION OF THE METHODS USED FOR MEASURING THE PROPERTIES OF THE ACTIVE MATERIALS GENERAL PROCEDURE

The materials, in a quantity of 10 mg, unless otherwise indicated, are incubated in 20 ml of water in a tube with a Teflon plug closed with a metal collar with a minimum headspace to allow stirring; the contaminating compound (up to 100 μl of an aqueous solution at a suitable concentration) is added with a 100 μl syringe; the stirring is carried out in a complete rotation system (powder mixer). At the end of the reaction, after 24 hours, at much higher times, therefore, than the equilibrium times determined for each adsorbent, the mixture is centrifuged for 15′ at 700 rpm to separate the adsorbing material and the non-adsorbed contaminant is determined from its residual concentration in solution. Each determination is carried out at least three times. For each determination the sample and control consisting of liquid and contaminant without adsorbing material are prepared under the same conditions. This procedure is followed for all the contaminants examined.

### Determination of the Equilibrium Times

From 10 mg to 1 g of adsorbing material are left to incubate with 20 ml of water containing from 100 ppb to 5 ppm of contaminant under stirring at room temperature for times varying from 15′ to 48 h. The equilibrium time is considered as being that over which the adsorption has not increased. In studying the effects of the conditions on the adsorption, the quantity of adsorbing material is used which determines the adsorption of at least half of the contaminant put in contact therewith.

Analysis of TCE, PCE, VC, Toluene, MTBE, Naphthalene, 2-methyl-naphthalene, Acenaphthene, Phenanthrene (Solution)

The aqueous solution is extracted with hexane in the ratio 5.666/1 (H₂O/hexane), in a tube analogous to the reaction tube; a millilitre of hexane is removed for analysis in GC-ECD, or GC-FID. The control consists of the sample, without the adsorbing material, subjected to the same treatment.

### GC/MS Analysis of Toluene/MTBE in a Mixture

The analysis is carried out from suitable aqueous solutions, measuring the contaminants in the headspace. The system used was GC/MS/DS Mod. MAT/90 of Finnigan; the gaschromatographic column used was a PONA (length 50 m×0.21 I.D. and 0.5 μm of film) of Hewlett-Packard. The flow of the carrier measured at 35° C. proved to be 0.6 ml/min (Helium). 500 μl of the headspace of each sample were injected, removing them with a (heated) gas syringe, from the phial kept for 2 h at 70° C. to reach equilibrium. The mass spectrometer operated in E.I. (electronic impact) at 70 eV and at a resolution of 1500 within the mass range of 30-120 a.m.u. and at a scanning rate which was such as to acquire a spectrum every 0.8 s.

### Effect of the Ionic Strength and pH on the Adsorption

The adsorption is carried out at different concentrations of CaCl₂: 5-100 mM; for the pH, solutions were tested at pH 6, 7, 8 obtained with an Na Phosphate 20 mM buffer.

Adsorption Reaction with Real Groundwater

The groundwater of a contaminated site was used. The chemical composition for the inorganic components tested us as follows:

Cations (mg/l)

Iron: 8.6; Nickel: 0.05; Manganese: 1.7; Lead: <0.01; Zinc: <0.8.

Sodium: 371; Potassium: 12; Magnesium: 60; Calcium: 298; Anions (mg/l)

Carbonates: 475; Chlorides: 2300; Nitrates 13; Nitrites 3; Sulfates 14000.

### EXAMPLE 1

Table 1 indicates the adsorption data obtained with TCE with different adsorbing materials.

TABLE 1
Adsorption of TCE with GAC and zeolites

| | Quantity | Quantity adsorbed |
|---|---|---|
| Adsorbent | (mg) | (of initial amount) |
| GAC | 10.8 | 55 |
| Silicalite | 11.1 | 94 |
| ZSM-5 | 13.3 | 97 |
| β-zeolite | 11.4 | 33 |

Contaminant: 300 ppb of TCE; Conditions: contact time 1 h

The zeolites examined, silicalite and ZSM-5, gave better performances, much higher than those of GAC. β-zeolite, although characterized by structural channels of 7.5 Å with slightly larger dimensions than those of silicalite and ZSM-5, both with channels of 5 Å, has a silica/aluminum ratio of 70 and therefore lower than both that of ZSM-5, 290, and that of silicalite, infinite.

These ratio values, indicating a higher polarity of β-zeolite, are, together with the different structural channel dimensions, responsible for its different behaviour.

### EXAMPLE 2

The adsorption kinetics were also determined for silicalite, by measuring the quantity of TCE adsorbed at various times. The following conditions were used in the example:

The adsorbing material, 10 mg, was incubated in 20 ml of water for 1 h in a 20 ml tube with a Teflon plug closed with a metallic collar with a minimum headspace to allow stirring; TCE, about 100 μl of an aqueous solution at a suitable concentration, to give an initial concentration of 300 ppb to the solution to be subjected to absorption, was subsequently added; the stirring was carried out in a mixer.

At the end of the reaction, 2 ml of aqueous phase are removed with a syringe and centrifuged in an Eppendorf phial at 15000 rpm for 5′ to separate the silicalite from the TCE solution.

TCE analysis (solution): the aqueous solution (1 ml) is extracted with hexane (0.5 ml); 100 μl of the extract are removed for analysis in GC-ECD. The control consists of the sample, without the adsorbing material, subjected to the same treatment.

The data at different times are indicated in Table 2.

TABLE 2
adsorption kinetics of TCE/Silicalite

| Quantity of silicalite | Time | TCE Adsorbed |
|---|---|---|
| (mg) | (minutes) | (%) |
| 10.8 | 5 | 76 |
| 10.1 | 10 | 81 |
| 10.3 | 15 | 90 |
| 10.5 | 30 | 92 |
| 11.3 | 45 | 93 |
| 10.0 | 60 | 93 |

These dosages seem to indicate very short adsorption times, in the order of 10 minutes or less.

### EXAMPLE 3

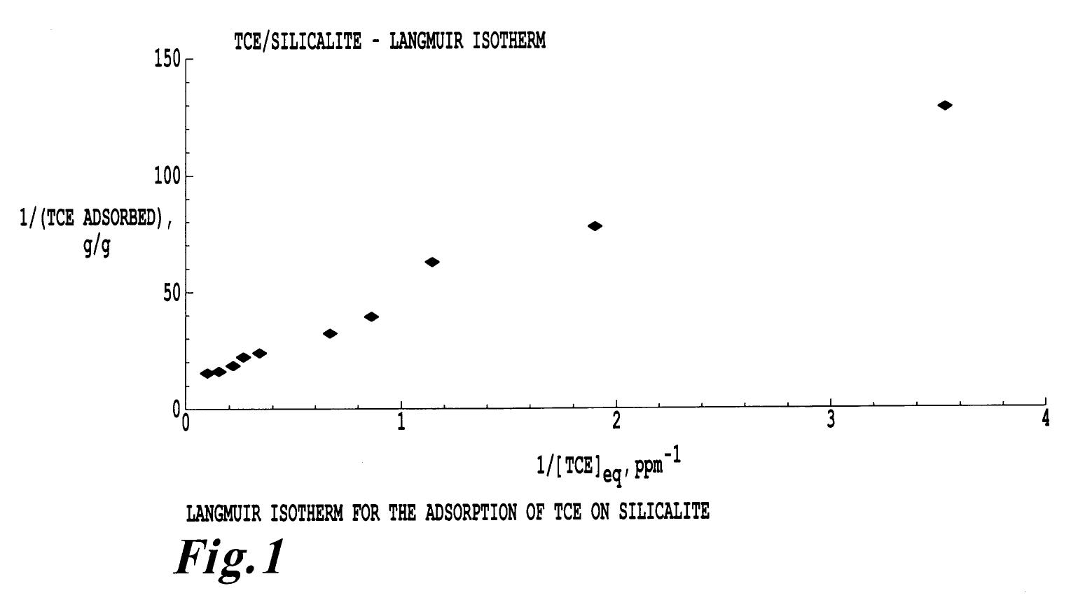

The adsorption isotherm of trichloroethylene on silicalite was obtained from adsorption experiments with initial concentrations within the range of 50 ppb-100 ppm. FIGS. 3 and 4 below indicate the results obtained; each point is the average of three determinations. The linearity of the curve of FIG. 1, represented according to the Langmuir method, shows the good correspondence of the data with the Langmuir isotherm (FIG. 1).

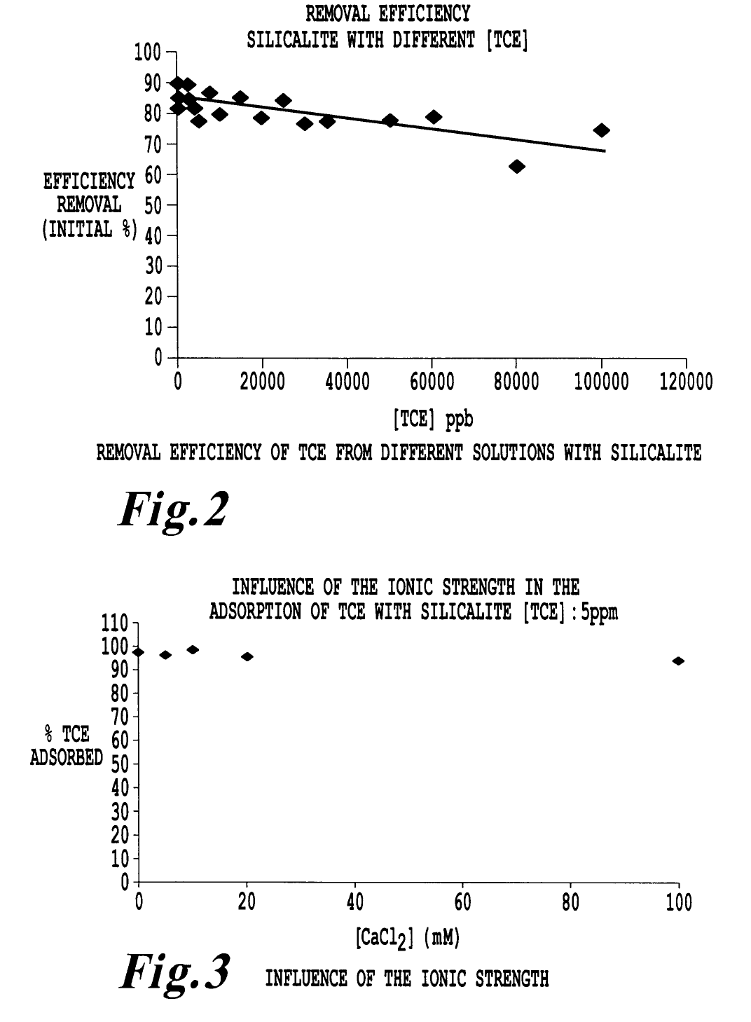

The adsorption efficiency under the experimental conditions (10 mg of adsorbing material in 20 ml of water, contaminating at different concentrations) is indicated in FIG. 2.

### EXAMPLE 4

Various adsorption experiments were carried out in the presence of strong concentrations of salts.

No significant effect of the ionic strength on the adsorption of TCE was observed (FIG. 3).

### EXAMPLE 5

### Adsorption on Silicalite of TCE in Real Groundwater

The influence of the cations and anions normally present in groundwater was examined using, in the reaction, real polluted groundwater whose content of sulfates was much higher than 10 g/l. 1100 pmm of TCE were added, to 20 ml of groundwater in the laboratory reaction. After incubation with 10 mg of silicalite, the water was analyzed and the quantity of TCE removed from the water proved to be higher than 95%, very clearly demonstrating the adsorption selectivity of the silicalite.

### EXAMPLE 6

### Adsorption of PCE

The experimental conditions were the same as those of TCE.

TABLE 3
Adsorption of PCE with silicalite

| | initial | [PCE] |
|---|---|---|
| Quantity of Silicalite | [PCE] | adsorbed |
| (mg) | (ppb) | (% initial) |
| 11.4 | 250 | 94 |
| 11.4 | 500 | 96 |
| 11.8 | 750 | 96 |
| 12.0 | 1000 | 97 |

### EXAMPLE 7

In order to demonstrate the competitive effects of the two compounds TCE and PCE, adsorption tests were effected with a mixture containing both. The results, indicated in Table 4 below, show the absence of inhibition of one contaminant with respect to the other. On increasing the concentration of PCE, in fact, from 250 to 1000 ppb, the adsorption of TCE was not substantially modified.

TABLE 4
Adsorption of mixtures of PCE and TCE

| Quantity | Quantity | Quantity | TCE | PCE |
|---|---|---|---|---|
| silicalite | TCE | PCE | adsorbed | adsorbed |
| (mg) | (ppb) | (ppb) | (%) | (%) |
| 12.0 | 1000 | 250 | 93 | 93 |
| 11.8 | 1000 | 500 | 93 | 95 |
| 10.8 | 1000 | 750 | 94 | 96 |
| 10.6 | 1000 | 1000 | 95 | 96 |

### EXAMPLE 8

### Adsorption of Vinyl Chloride (VC)

An examination of aliphatic organo-chlorinated compounds cannot exclude VC which is the most difficult compound to degrade in this group.

FIG. 4 below indicates the Freundlich isotherm obtained in the treatment of VC on silicalite; conditions: 10 mg of adsorbing material, contaminant between 550 and 5550 ppb, in 20 ml of water.

### EXAMPLE 9

In this example, the adsorption capacities of zeolites and GAC were compared.

The results obtained, under analogous conditions to the previous ones, are indicated in Table 5.

TABLE 5
Adsorption of VC with silicalite, ZSM-5 and GAC

| | Quantity of | initial | VC |
|---|---|---|---|
| Type of | Adsorbent | VC | Adsorbed |
| Adsorbent | (mg) | (ppb) | (%) |
| Silicalite | 10 | 555 | 94 |
| Silicalite | 10 | 1105 | 92 |
| Silicalite | 10 | 1660 | 93 |
| Silicalite | 10 | 5550 | 94 |
| ZSM-5 | 10 | 5550 | 99 |
| GAC | 10 | 555 | 45 |

### EXAMPLE 10

### Adsorption of Toluene

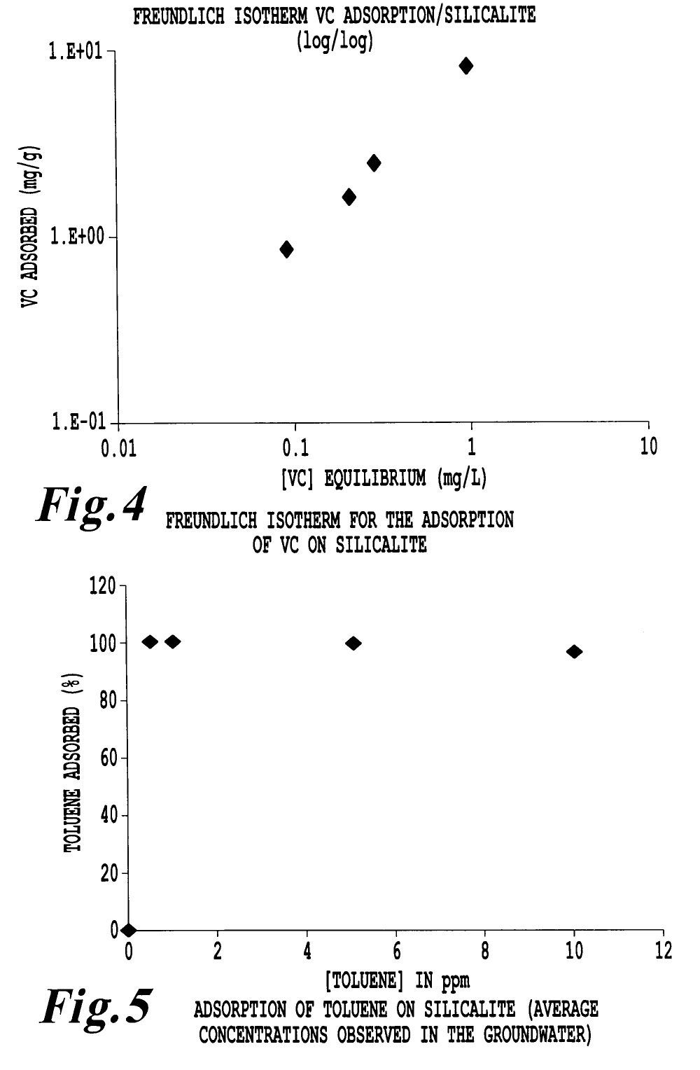

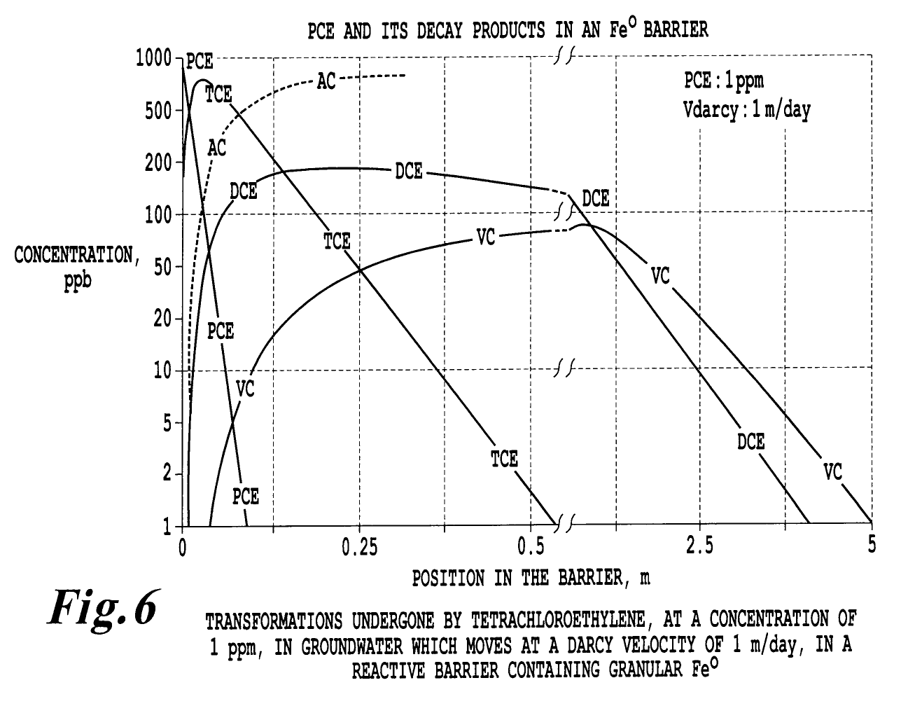

Toluene is considered as being the most representative BTEX compound present in fuels, and as such is normally the reference chemical compound of aromatic hydrocarbons. The results obtained at concentrations normally found in contaminated groundwater are indicated in FIG. 5.

A comparison between zeolites differing in the adsorption of toluene is provided in Table 6 below.

TABLE 6
Comparison between zeolites differing
in the adsorption of toluene.

| | | [Toluene] | |
|---|---|---|---|
| | Quantity in the test | initial | Toluene |
| Type of zeolite | (mg) | (ppm) | adsorbed (%) |
| Silicalite | 10.3 | 50 | 75 |
| ZSM-5 | 10.2 | 50 | 85 |
| β-zeolite | 10.2 | 50 | 15 |

The results showed that ZSM-5 and silicalite have a comparable behaviour.

### EXAMPLE 11

In the comparison between silicalite, ZSM-5 and GAC, for the adsorption of contaminated mixtures, organochlorinated and aromatic hydrocarbons, the results indicated in the following table were obtained.

Table 7. Comparison between silicalite, ZSM-5 and GAC in the adsorption of Toluene+PCE+TCE mixtures

Conditions: the same as the previous examples, 20 ml of water containing the contaminants at the concentrations indicated, contact times higher than the equilibrium time.

TABLE 7
Comparison between silicalite, ZSM-5 and GAC in the
adsorption of Toluene + PCE + TCE mixtures

| | Toluene | PCE | TCE | Toluene | PCE | TCE |
|---|---|---|---|---|---|---|
| Type | Initial concentration | | | Quantity adsorbed | | |
| Adsorbent | (ppb) | | | (%) | | |
| Silicalite | 5000 | 1000 | 1000 | 93 | 92 | 95 |
| ZSM-5 | 5000 | 1000 | 1000 | 98 | 98 | 99 |
| GAC | 5000 | 1000 | 1000 | 78 | 48 | 52 |

The results indicate the absence of inhibition between the different molecules with respect to the absorption sites of the zeolite.

### EXAMPLE 12

Both silicalite and ZSM-5 seem to be also effective in the adsorption of MTBE, a compound which is difficult to biodegrade and difficult to treat with activated carbon. The comparison is provided in Table 8.

TABLE 8
Comparison between silicalite and
ZSM-5 in the adsorption of MTBE

| | Quantity | initial [MTBE] | [MTBE] absorbed |
|---|---|---|---|
| Type of zeolite | (mg) | (ppb) | (%) |
| Silicalite | 10.4 | 1000 | 96 |
| ZSM-5 | 10.2 | 1000 | 98 |

### EXAMPLE 13

The study of MTBE was further developed with respect to GAC, with different contact times: with silicalite it was 1 h, for carbon 4 h. The results are indicated below.

TABLE 9
Comparison between activated carbon and
silicalite for the adsorption of MTBE

| | Quantity of | initial | MTBE |
|---|---|---|---|
| Type of | adsorbent | [MTBE] | adsorbed |
| adsorbent | (mg) | (ppb) | (%) |
| Silicalite | 10.1 | 1000 | 97 |
| Silicalite | 10.2 | 5000 | 96 |
| Silicalite | 10.0 | 20000 | 90 |
| GAC | 10.3 | 1000 | 80 |
| GAC | 10.1 | 20000 | 51 |
| GAC | 50.4 | 1000 | 88 |
| GAC | 50.2 | 20000 | 90 |

As shown by the results, the comparison is in favour of the silicalite.

### EXAMPLE 14

Mixtures of Toluene/MTBE were tested with silicalite to show any possible reciprocal inhibitions; the comparison of silicalite with GAC was then effected on these mixtures of contaminants.

TABLE 10
Adsorption of mixtures of Toluene/MTBE:GAC/Silicalite
comparison

| | Quantity | initial | initial | MTBE | Toluene |
|---|---|---|---|---|---|
| Type of | adsorbent | MTB | Toluene | adsorbed | adsorbed |
| adsorbent | (mg) | (ppb) | (ppb) | (%) | (%) |
| Silicalite | 11.2 | 1000 | 5000 | 97 | 95 |
| GAC | 11.2 | 1000 | 5000 | 69 | 82 |
| | 51.5 | 1000 | 5000 | 82 | 83 |

In conclusion, the adsorbing capacities of silicalite were demonstrated, which proved to be very similar to those shown by the commercial product ZSM-5. The fact that these adsorbents have better adsorption characteristics than GAC was confirmed.

### EXAMPLE 15

### Polycyclic Aromatic Hydrocarbons

Naphthalene was examined as aromatic compound with two condensed rings and adsorption experiments were effected with Silicalite, ZSM-5, MSA, ERS-8, Mordenite, GAC.

Conditions: equilibrium time 24 h, 10 mg of adsorbent, 1 ppm of naphthalene, in 22 ml of water.

TABLE 11
Adsorption of Naphthalene with different adsorbents.

| | Quantity of | Initial | Naphthalene |
|---|---|---|---|
| Type of | adsorbent | Naphthalene | adsorbed |
| adsorbent | (mg) | (ppb) | (%) |
| Silicalite | 10.2 | 1000 | 18 |
| ZSM-5 | 10.3 | 1000 | 33 |
| MSA | 10.5 | 1000 | 5 |
| ERS-8 | 10.2 | 1000 | 5 |
| Mordenite | 10.5 | 1000 | 100 |
| GAC | 11.2 | 1000 | 72 |
| GAC | 50.5 | 1000 | 81 |

### EXAMPLE 16

Molecules of components of gas oil were also examined, in particular 2-methylnaphthalene, acenaphthene and phenanthrene; the results obtained with Mordenite and with MSA under the conditions of 10 mg of adsorbent in 22 ml of water containing 1 ppm of contaminant are indicated in Table 12 below.

TABLE 12
Adsorption of polycyclic aromatic hydrocarbons with mordenite and MSA

| | initial | | | | | |
|---|---|---|---|---|---|---|
| | 2-methyl- | initial | initial | 2-methyl- | | |
| Type of | Naphthalene | Acenaphthene | Phenanthrene | Naphthalene | Acenaphthene | Phenanthrene |
| adsorbent | (ppb) | (ppb) | (ppb) | adsorbed (%) | Adsorbed (%) | Adsorbed (%) |
| Mordenite | 1000 | 1000 | 1000 | 100 | 95 | 100 |
| MSA | 1000 | 1000 | 1000 | 15 | 5 | 22 |

### EXAMPLE 17

Comparison between a metallic iron barrier and a zeolite, barrier.

FIG. 6 shows the chain of transformations undergone by tetrachloroethylene, at a concentration of 1 ppm, in groundwater which moves at a Darcy velocity of 1 m/day, in a reactive barrier containing granular Fe°. The kinetics were calculated from the data of Tratnyek et al.

(P. G. Tratnyek, T. L. Johnson, M. M. Scherer, G. R. Eykholt, GWMR, Fall 1997, pages 108-114), assuming that the Fe has a reactive surface of 3.5 m²/cm³, i.e. among the highest specified in literature. The concentration trend of the decay products is indicated, in relation to the run in the barrier: tetrachloroethylene (PCE)→trichloroethylene (TCE)→dichloroethylene (DCE)+acetylene and chloroace tylene (AC); dichloroethylene→vinyl chloride (VC)→ethylene. The chloroacetylene degrades rapidly into acetylene and vinyl chloride (FIG. 6).

PCE is rapidly decomposed, but the further reaction of its decay products is slower, requiring about two days residence, corresponding to a run of a few metres in the barrier, to obtain the degradation of the last dangerous species of the chain, vinyl chloride. This makes it necessary to have a barrier thickness, under these conditions, of at least 3-5 metres.

For iron barriers, the well-known limits, amply indicated in literature, should be pointed out, according to which the efficacy is acknowledged only for a few groups of reducible products, aliphatic chlorinated products and heavy metals with a high oxidation number, for example Cr⁺⁶, U⁺⁶; the functioning dependence on the presence of ions which considerably reduce the performances, is also fully described (Dahmke, A., E. Ebert, R. Kober and D. Schafer. 2000. Laboratory and field results of Fe (0) reaction walls—a first resumè. In: Proc. Intl. Conf. Groundwater Research, Rosbijerg et al. Eds. Copenhagen (2000), page 395-396.

### EXAMPLE 18

Functioning of a zeolite barrier.

Zeolites, even with relatively large particles sizes, thanks to their microporous structure, allow a much more rapid adsorption, with times which can easily be in the order of a second and, consequently, in a run of fraction of cm in a barrier.

The thickness of a zeolite absorbing barrier does not therefore depend on the kinetics, but only on the absorbing capacity of the zeolite itself with respect to the species to be adsorbed.

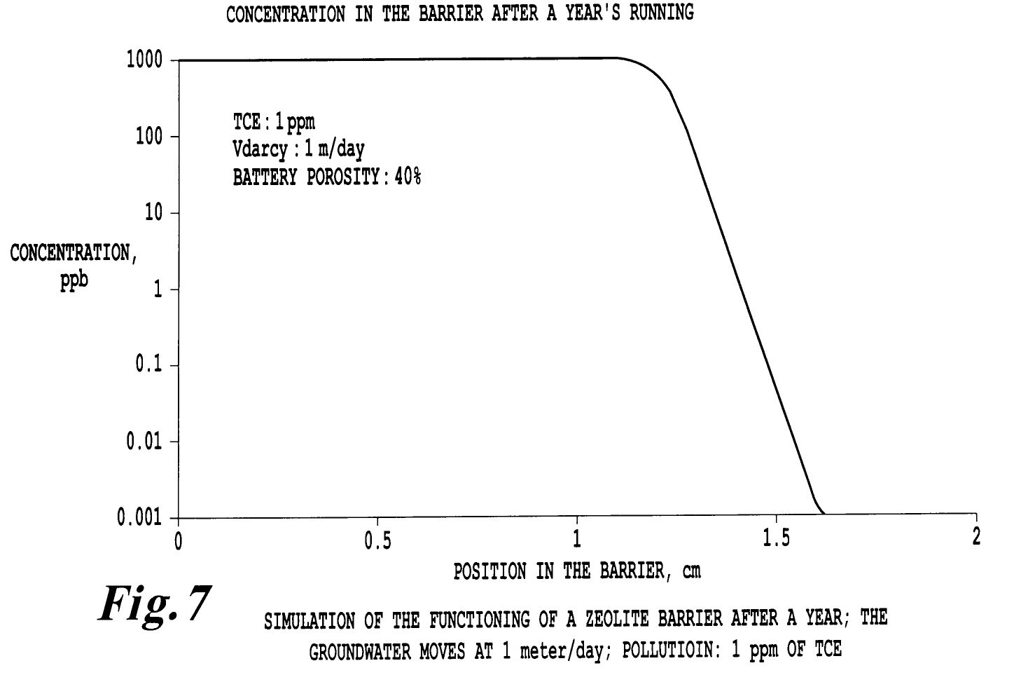

FIG. 7 shows the simulation, based on the adsorption isotherm data, measured on the materials used in the process, object of the present invention, of the functioning of a zeolite barrier after a year; the groundwater, which moves at 1 metre/day, has a pollution of 1 ppm of trichloroethylene (TCE). After 1 year, the first layers of the barrier, for a thickness of about 1 cm, are therefore saturated, having adsorbed the whole quantity of TCE corresponding to their capacity, on the basis of the isotherm.

Correspondingly, the TCE passes with an unaltered concentration. Downstream of this layer, the concentration drops extremely rapidly (FIG. 7).

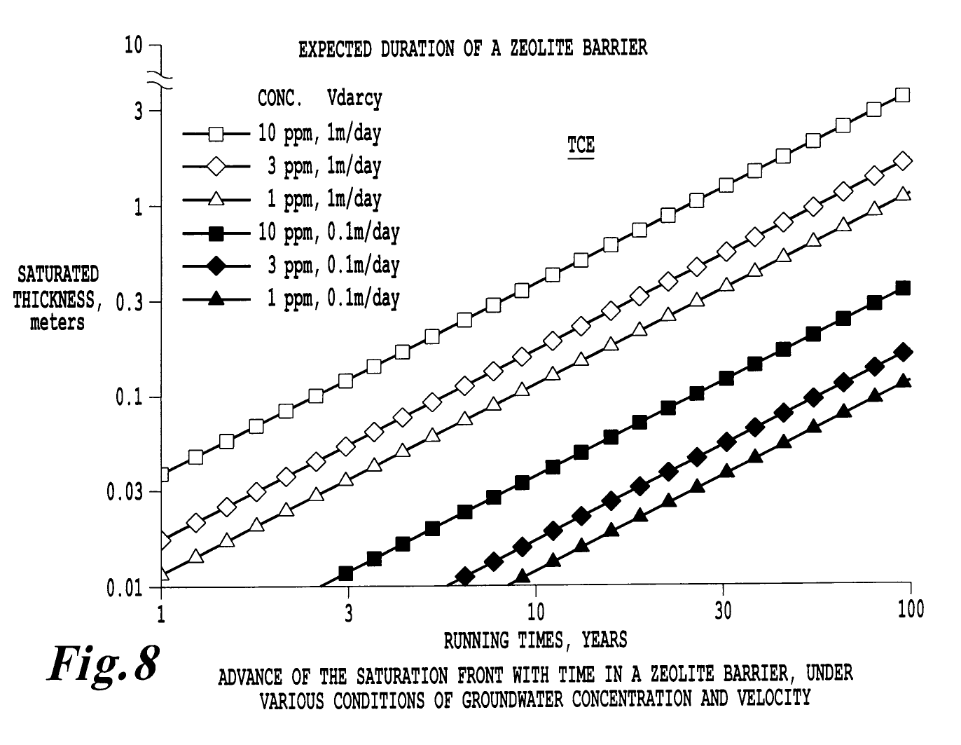

FIG. 8, again calculated with the data of the materials used in the process, object of the invention, shows, on the other hand, the advance of the saturation front in the time calculated, in a zeolite barrier, under various conditions of groundwater concentrations and velocity (FIG. 8).

This graph can therefore be used for estimating the thickness required for maintaining the barrier effective for a certain period of time, assuming that the groundwater only contains TCE. If other organic molecules are present, the thicknesses necessary for absorbing these other molecules must be naturally added to that obtained from FIG. 8.

One of the strong points of zeolites is that they do not have adsorption inhibition, of one organic molecule on the part of another and, above all, that there is no competition for the adsorption sites on the part of ions up to high concentrations. This is particularly important as, if the material also absorbed ions, it would very rapidly become exhausted as the ions are often hundreds or thousands of times more numerous than the organic molecules.

1-8. (canceled)

9. A process for the treatment of water contaminated by dichloroethylene (DCE), vinyl chloride (VC), methyl-tertbutylether (MTBE), naphthalene, 2-methyl-naphthalene, acenaphthene, or phenanthrene, or their mixtures comprising:
passing water contaminated by dichloroethylene (DCE), vinyl chloride (VC), methyl-tertbutylether (MTBE), naphthalene, 2-methyl-naphthalene, acenaphthene, phenanthrene, or their mixtures
through a permeable reactive barrier (PRB),
wherein the permeable reactive barrier comprises a reactive medium that consists of one or more apolar zeolites having a silica/alumina ratio >50, and
wherein said permeable reactive barrier contains structural channels having dimensions similar to those of the molecules of the contaminating compound(s).

10. The process of claim 9, comprising treating water contaminated by MTBE, DCE or VC.

11. The process according to claim 9, wherein the zeolite has structural channels having dimensions ranging from 4.5 to 7.5 Angstroms.

12. The process according to claim 11, wherein the zeolite has structural channels having dimensions ranging from 5.0 to 7.0 Angstroms.

13. The process according to claim 9, wherein the zeolite has a silica/alumina ratio >200.

14. The process according to claim 13, wherein the zeolite consists of silicalite, ZSM-5 zeolite, or mordenite.

15. The process according to claim 9, wherein the water is treated with a mixture of zeolites having a silica/alumina ratio >50 and presenting structural channels having dimensions similar to those of the molecules of the contaminating compounds, in relation to the type of contaminants present in the water itself.

16. The process according to claim 9, wherein the water is contaminated by dichloroethylene and the zeolite is ZSM-5 zeolite.

17. The process according to claim 9, wherein the apolar compounds consist of at least one halogenated solvent, aliphatic compound, aromatic compound, or their mixtures.

18. The process according to claim 17, wherein the
halogenated solvent consists of carbon tetrachloride, tetrachloroethylene (PCE), trichloroethylene (TCE), dichloroethylene (DCE), vinylchloride (VC),
the aliphatic and aromatic compound consists of methyl-terbutylether (MTBE), BTEX (benzene, toluene, ethylbenzene, xylene), naphthalene, 2-methyl-naphthalene, acenaphthene, or phenanthrene.

19. The process according to claim 10, wherein the zeolite has structural channels having dimensions ranging from 4.5 to 7.5 Angstroms.

20. The process according to claim 19, wherein the zeolite has structural channels having dimensions ranging from 5.0 to 7.0 Angstroms.

21. The process according to claim 10, wherein the zeolite has a silica/alumina ratio >200.

22. The process according to claim 21, wherein the zeolite consists of silicalite, ZSM-5 zeolite, or mordenite.

23. The process according to claim 10, wherein the water is treated with a mixture of zeolites having a silica/alumina ratio >50 and having structural channels having dimensions similar to those of the molecules of the contaminating compounds in the water itself.

24. The process according to claim 10, wherein the water is contaminated by dichloroethylene and the zeolite is ZSM-5 zeolite.

25. The process of claim 9, wherein the permeable reactive barrier is placed in situ perpendicular to the flow of the groundwater.

26. The process of claim 9, wherein the apolar zeolite comprises ZSM-zeolite having a Si/Al ratio of >200 and the contaminated water contains an aliphatic, halogen-aliphatic, or mono-aromatic apolar contaminant; or
wherein the apolar zeolite comprises mordenite having a Si/Al ratio of >200 and the contaminated water contains apolar aromatic molecules with two or more aromatic rings, which may be halogen or alkyl-substituted.

27. The process of claim 9, wherein the contaminated water contains MTBE and the zeolite is mordenite having an Si/Al ratio (“SAR”) of >200.

28. The process of claim 10, wherein the contaminated water contains DEC or VC and the zeolite is ZSM-5 having an Si/Al ratio (“SAR”) of >200.

29. A process for treating contaminated water comprising:
passing water contaminated by vinyl chloride (VC) or methyl-tertbutylether (MTBE) through a permeable reactive barrier (PRB) which contains one or more apolar zeolites having a silica/alumina ratio >50 and which contains structural channels ranging from 4.5 Å to 7.5 Å.

30. The process of claim 29, wherein the one or more apolar zeolites is mordenite having an SAR of at least 200.

31. A process for the treatment of water contaminated by an aliphatic, halogen-aliphatic, or mono-aromatic apolar contaminant comprising:
passing water contaminated by an aliphatic, halogen-aliphatic, or mono-aromatic apolar contaminant through a permeable reactive barrier (PRB),
wherein the permeable reactive barrier comprises ZSM-5 zeolite having an Si/Al ratio of >200 and structural channels having dimensions ranging from 4.5 to 7.5 Angstroms and the contaminated water contains an aliphatic, halogen-aliphatic, or mono-aromatic apolar contaminant; or
wherein the permeable reactive barrier comprises mordenite having a Si/Al ratio of >200 and structural channels having dimensions ranging from 4.5 to 7.5 Angstrom is and the contaminated water contains apolar aromatic molecules with two or more aromatic rings, which may be halogen or alkyl-substituted.
